(19) United States
(12) Patent Application Publication
(10) Pub. No.: US 2025/0110252 A1
(43) Pub. Date: Apr. 3, 2025

(54) INDUCTIVE SCANNER AND METHOD FOR INDUCTIVE SCANNING

(71) Applicant: Rohde & Schwarz GmbH & Co. KG, Munich (DE)

(72) Inventors: Julian LANDESBERGER, Munich (DE); Gilles SANTI, Lausanne (CH); Alexander BAYER, Munich (DE); Beryl YERSIN, Echallens (CH)

(73) Assignee: Rohde & Schwarz GmbH & Co. KG, Munich (DE)

(21) Appl. No.: 18/477,688

(22) Filed: Sep. 29, 2023

(51) Int. Cl. G01V 3/38; G01V 3/10; G05B 13/02

(52) U.S. Cl. CPC G01V 3/38; G01V 3/104; G05B 13/027

(57) ABSTRACT

An inductive scanner, especially an inductive shoe and/or foot scanner, is provided. Said inductive scanner comprises at least three inductive transceiver elements for inductively transmitting and/or receiving to form corresponding magnetic fields, and a control unit connected to said at least three inductive transceiver elements. In this context, the at least three inductive transceiver elements are arranged at different distance from one another such that the corresponding magnetic fields between at least one or each respective pair of the at least three inductive transceiver elements have different field distributions in three-dimensional space. In addition to this, the control unit is configured to infer a respective location of an object and/or materials affecting the corresponding magnetic fields on the basis of the different field distributions

### TECHNICAL FIELD

The present disclosure relates to an inductive scanner and a method for inductive scanning.

### BACKGROUND ART

Generally, in times of an increasing number of applications employing imaging with respect to objects being hidden or covered, respectively, there is a growing need of an inductive scanner and a method for inductive scanning to make such applications particularly accurate and efficient, thereby ensuring that an object cannot only be detected but also characterized or imaged, respectively.

U.S. Pat. No. 8,352,015 B2 discloses a method and apparatus for determining and tracking location of a metallic object in a living body, and then directing a second modality such as ultrasound waves to the determined location. The metal detector is a radar detector adapted to operate on a living body. The adaption includes disposing a transfer material having electromagnetic properties similar to the body between the radar detector and the living body, electrocardiogram gating the radar detector, and/or employing an optimal estimator with a model of expected stent movement in a living body. Applications include determination of extent of in-stent restenosis, performing therapeutic thrombolysis, or determining operational features of a metallic implant. In the light of such applications, for instance, a combined instrument determines in-vivo the location of stent and directs ultrasound waves to the determined location, said combined instrument including a standard ultrasound probe rigidly connected by any suitable physical arrangement to a metal detector. Said metal detector may comprise a magnetometer, for example, of the pulse-induction type, or other metal detector. The rigid connection between ultrasound probe and metal detector ensures registration, i.e. both operate in the same coordinate system. Thus, the rigid connection serves to guide and direct the ultrasound probe at a location of the stent or other metallic object in the living body determined by the metal detector.

Disadvantageously, at least two different techniques are necessary to firstly detect and then to characterize, especially in the sense of imaging, the correspondingly desired object. In other words, the metal detector does only allow for detecting an object but not for characterizing or imaging it.

### SUMMARY

Thus, there is a need to provide an inductive scanner and a method for inductive scanning, wherein an object cannot only be detected but also characterized or imaged, respectively, in a particularly accurate and efficient manner.

This is achieved by the embodiments provided in the enclosed independent claims. Advantageous implementations of the present disclosure are further defined in the dependent claims.

According to a first aspect of the present disclosure, an inductive scanner is provided. Said inductive scanner comprises at least three inductive transceiver elements for inductively transmitting and/or receiving to form corresponding magnetic fields, and a control unit connected to said at least three inductive transceiver elements. In this context, the at least three inductive transceiver elements are arranged at different distance from one another such that the corresponding magnetic fields between at least one or each respective pair of the at least three inductive transceiver elements have different field distributions in three-dimensional space. In addition to this, the control unit is configured to infer a respective location of an object and/or materials affecting the corresponding magnetic fields on the basis of the different field distributions. Advantageously, an object cannot only be detected but also characterized or imaged, respectively, in a particularly accurate and efficient manner.

According to an implementation form of the first aspect of the present disclosure, the control unit is configured to apply various excitation patterns to at least a part or each of the at least three inductive transceiver elements. Advantageously, for instance, while a part of the at least three inductive transceiver elements can receive or measure continuously, another part of the at least three inductive transceiver elements can emit according to said excitation patterns.

According to a further implementation form of the first aspect of the present disclosure, the control unit is configured to determine a three-dimensional shape with respect to the object and/or materials based on applying the various excitation patterns. Advantageously, for example, an imaging or tomography result can be provided in a particularly efficient manner.

According to a further implementation form of the first aspect of the present disclosure, the control unit is configured to change the various excitation patterns in each of various time slots. Advantageously, for instance, inductive imaging or tomography can be achieved in a time-saving manner, thereby increasing efficiency.

According to a further implementation form of the first aspect of the present disclosure, at least a part or each of the at least three inductive transceiver elements comprises or is at least one coil, especially at least one metal detection coil. Advantageously, for example, complexity can be reduced, which leads to an increased efficiency.

According to a further implementation form of the first aspect of the present disclosure, the control unit comprises or is a controller or an application-specific integrated circuit, especially an application-specific integrated circuit acquisition unit. Advantageously, for instance, inefficiencies can further be reduced.

According to a further implementation form of the first aspect of the present disclosure, the inductive scanner comprises or is an inductive shoe and/or foot scanner especially for security areas such as airport security. Advantageously, for example, such a scanner can also be used for loss prevention, protection of restricted areas, or border customs.

According to a further implementation form of the first aspect of the present disclosure, the control unit is configured to determine if the object and/or materials is a threat based on the respective location and/or three-dimensional shape. Advantageously, for instance, an alarm can automatically be reported.

According to a further implementation form of the first aspect of the present disclosure, the control unit is configured to use machine learning and/or artificial intelligence and/or at least one artificial neural network to classify the object and/or materials. Advantageously, for example, anomalies in the corresponding imaging or tomography results which are not to be determined as a threat can reliably be discarded exemplarily as disturbance or noise.

According to a second aspect of the present disclosure, a method for inductive scanning is provided. Said method comprises the steps of forming corresponding magnetic fields by inductively transmitting and/or receiving with the aid of at least three inductive transceiver elements, arranging the at least three inductive transceiver elements at different distance from one another such that the corresponding magnetic fields between at least one or each respective pair of the at least three inductive transceiver elements have different field distributions in three-dimensional space, and inferring a respective location of an object and/or materials affecting the corresponding magnetic fields on the basis of the different field distributions especially with the aid of a control unit connected to the at least three inductive transceiver elements. Advantageously, an object cannot only be detected but also characterized or imaged, respectively, in a particularly accurate and efficient manner.

Before implementation forms of the second aspect of the present disclosure are discussed in the following, it is noted that all the explanations or advantages, respectively, regarding the corresponding implantation forms of the first aspect of the present disclosure as stated above can analogously apply for the following implementation forms.

According to an implementation form of the second aspect of the present disclosure, the method further comprises the step of applying various excitation patterns to at least a part or each of the at least three inductive transceiver elements especially with the aid of the control unit.

According to a further implementation form of the second aspect of the present disclosure, the method further comprises the step of determining a three-dimensional shape with respect to the object and/or materials based on applying the various excitation patterns especially with the aid of the control unit.

According to a further implementation form of the second aspect of the present disclosure, the method further comprises the step of changing the various excitation patterns in each of various time slots especially with the aid of the control unit.

According to a further implementation form of the second aspect of the present disclosure, at least a part or each of the at least three inductive transceiver elements comprises or is at least one coil, especially at least one metal detection coil.

According to a further implementation form of the second aspect of the present disclosure, the control unit comprises or is a controller or an application-specific integrated circuit, especially an application-specific integrated circuit acquisition unit.

According to a further implementation form of the second aspect of the present disclosure, the method comprises or is a method for inductive shoe and/or foot scanning especially used in the context of security areas such as airport security.

According to a further implementation form of the second aspect of the present disclosure, the method further comprises the step of determining if the object and/or materials is a threat based on the respective location and/or three-dimensional shape especially with the aid of the control unit.

According to a further implementation form of the second aspect of the present disclosure, the method further comprises the step of using machine learning and/or artificial intelligence and/or at least one artificial neural network to classify the object and/or materials.

### BRIEF DESCRIPTION OF THE DRAWINGS

The above-described aspects and implementation forms of the present disclosure will be explained in the following description of specific embodiments in relation to the enclosed drawings, in which:

FIG. 1 shows an exemplary embodiment of the first aspect of the present disclosure;

FIG. 2A shows a first exemplary embodiment of an inductive transceiver element field;

FIG. 2B shows a second exemplary embodiment of an inductive transceiver element field;

FIG. 2C shows a third exemplary embodiment of an inductive transceiver element field; and

FIG. 3 shows a flow chart of an exemplary embodiment of the second aspect of the present disclosure.

### DETAILED DESCRIPTIONS OF EMBODIMENTS

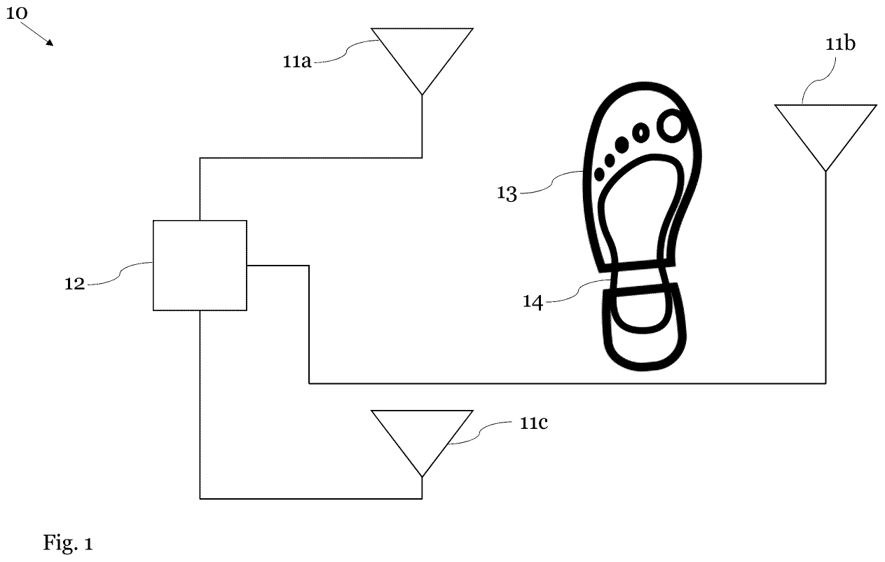

With respect to FIG. 1, an exemplary embodiment of the inductive scanner 10 according to the first aspect of the present disclosure is depicted. In this exemplary case, the inductive scanner 10 is used for scanning a shoe 13 and/or foot 14.

As it can be seen from FIG. 1, said inductive scanner 10 comprises at least three inductive transceiver elements, exemplarily the three inductive transceiver elements 11a, 11b, 11c, for inductively transmitting and/or receiving to form corresponding magnetic fields, and a control unit 12 connected to said at least three inductive transceiver elements or said three exemplary inductive transceiver elements 11a, 11b, 11c, respectively.

In this context, the at least three inductive transceiver elements or the three exemplary inductive transceiver elements 11a, 11b, 11c, respectively, are arranged at different distance from one another such that the corresponding magnetic fields between at least one or each respective pair of the at least three inductive transceiver elements, exemplarily each respective of the three inductive transceiver elements 11a, 11b, 11c, have different field distributions in three-dimensional space.

In addition to this, the control unit 12 is configured to infer a respective location of an object and/or materials affecting the corresponding magnetic fields on the basis of the different field distributions. In this exemplary case, said object or materials, respectively, can be understood as the shoe 13 and/or foot 14 and/or an object hidden and/or covered by the shoe 13 and/or materials hidden and/or covered by the shoe 13.

In this context, the control unit 12 can especially be configured to provide imaging results, preferably tomography results, based on the different field distributions.

It is noted that it might be particularly advantageous if the control unit 12 is configured to apply various excitation patterns to at least a part or each of the at least three inductive transceiver elements or the three exemplary inductive transceiver elements 11a, 11b, 11c, respectively.

In this context, a part, especially the half, of the at least three inductive transceiver elements or of the three exemplary inductive transceiver elements 11a, 11b, 11c, respectively, may be configured as inductive emitter elements being preferably excited by various excitation patterns, whereas another part, especially the other half, of the at least three inductive transceiver elements or of the three exemplary inductive transceiver elements 11a, 11b, 11c, respectively, may be configured as inductive receiver elements being preferably measuring continuously.

For the sake of completeness, it is noted that in the case that number of the at least three inductive transceiver elements is an odd number, the above-mentioned half or other half, respectively, can be understood as the corresponding next smaller integer number or the corresponding next larger integer number, respectively.

It is further noted that the control unit 12 may be configured to determine a three-dimensional shape with respect to the object and/or materials or the shoe 13 and/or foot 14, respectively, based on applying the various excitation patterns.

Moreover, it might be particularly advantageous if the control unit 12 is configured to change the various excitation patterns in each of various time slots.

Furthermore, at least a part or each of the at least three inductive transceiver elements or of the three exemplary inductive transceiver elements 11a, 11b, 11c, respectively, may comprise or be at least one coil, especially at least one metal detection coil.

In this context, a respective central axis of at least a first part or each of the at least three inductive transceiver elements or the three exemplary inductive transceiver elements 11a, 11b, 11c, respectively, may be oriented in a first direction or different directions.

In addition to this or as an alternative, a respective central axis of at least a second part or each of the at least three inductive transceiver elements or the three exemplary inductive transceiver elements 11a, 11b, 11c, respectively, may be oriented in a second direction or different directions.

With respect to the above-mentioned first direction and second direction, it is noted that it might be particularly advantageous if the first direction is perpendicular or substantially perpendicular to the second direction.

With respect to the above-mentioned term “substantially perpendicular” it is noted that said term can especially be understood as an angle deviating not more than 35 percent, preferably not more than 25 percent, more preferably not more than 15 percent, most preferably not more than 5 percent, from 90 degrees.

Furthermore, with respect to the control unit 12, it is noted that it might be particularly advantageous if the control unit 12 comprises or is a controller or an application-specific integrated circuit, especially an application-specific integrated circuit acquisition unit.

As already mentioned above, the inductive scanner 10 is exemplarily used for scanning the shoe 13 and/or foot 14. Accordingly, it might be particularly advantageous if the inductive scanner 10 is an inductive shoe and/or foot scanner especially for security areas such as airport security, loss prevention, protection of restricted areas, or border customs.

In this context, the control unit 12 can be configured to determine if the object and/or materials, especially an object hidden and/or covered by the shoe 13 and/or a sock and/or a trouser leg and/or materials hidden and/or covered by the shoe 13 and/or a sock and/or a trouser leg, is a threat based on the respective location and/or three-dimensional shape.

Moreover, it is noted that it might be particularly advantageous if the control unit 12 is configured to decide whether an anomaly in the corresponding imaging or tomography results in a threat report or not preferably based on determined position and/or orientation and/or size with respect to the object and/or materials especially hidden and/or covered by the shoe 13 and/or a sock and/or a trouser leg.

For instance, the control unit 12 can be configured to consider long metallic items aligned with the foot 14 and/or the corresponding lower leg, such as knives, to be dangerous or a threat respectively. Additionally or alternatively, the control unit 12 can be configured to discard the object if the object is determined to be short. Further additionally or further alternatively, the control unit 12 can be configured to attribute objects which are determined to be positioned and/or oriented in a way that makes them unlikely to be hidden on the human body, especially in the area of the foot and/or lower leg, to disturbance or noise and/or to discard such objects.

It is further noted that it might be particularly advantageous if the control unit 12 is configured to use machine learning and/or artificial intelligence and/or at least one artificial neural network to classify the object and/or materials especially hidden and/or covered by the shoe 13 and/or a sock and/or a trouser leg.

Furthermore, it might be particularly advantageous if the inductive scanner 10 or the inductive shoe and/or foot scanner is configured to scan a pair of shoes and/or a pair of feet in parallel and/or simultaneously. In this context, the control unit 12 may be configured to regard an asymmetry in the corresponding scan between the shoes and/or feet.

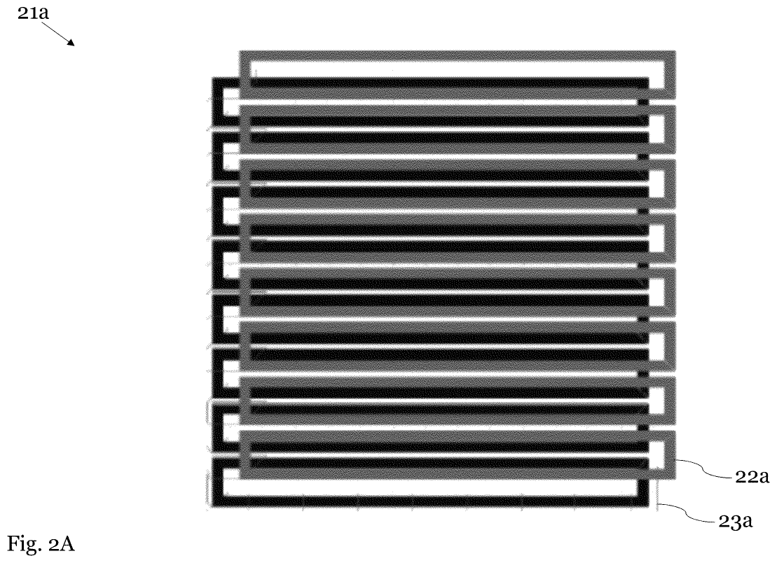

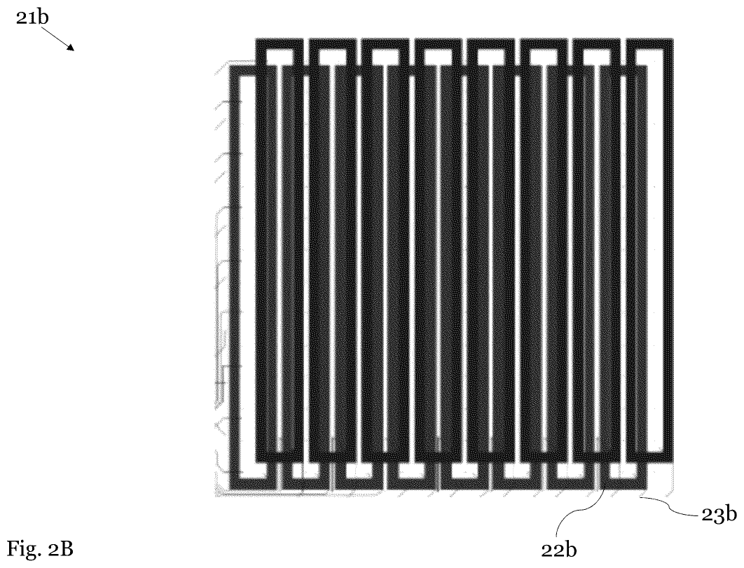

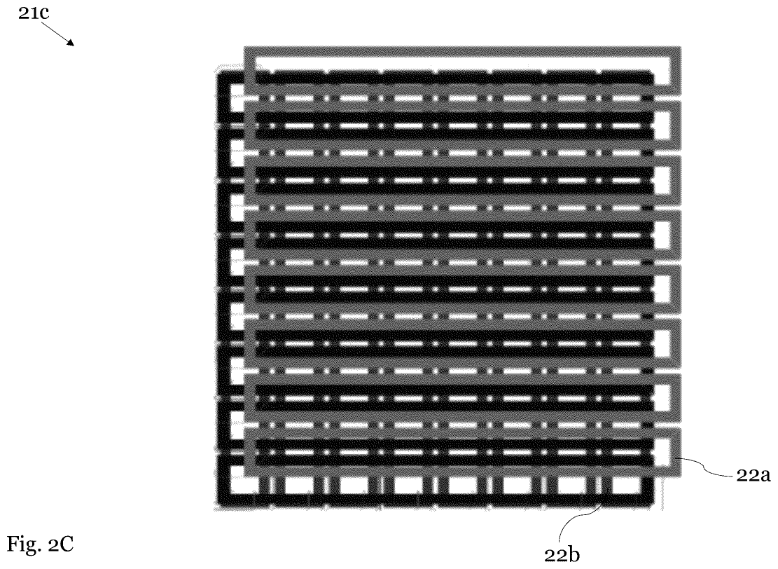

Again, with respect to the at least three inductive transceiver elements or the three exemplary inductive transceiver elements 11a, 11b, 11c, respectively, it is noted that three exemplary embodiments thereof as inductive transceiver element fields are illustrated by FIG. 2A, FIG. 2B, and FIG. 2C.

In accordance with the first exemplary embodiment 21a of FIG. 2A, said first exemplary embodiment 21a comprises a first multitude of coils, wherein one of said coils is representatively equipped with reference sign 22a.

At least a part or each of the coils of said first multitude is oriented according to a first direction, especially a horizontal direction or x-direction. Furthermore, the first exemplary embodiment 21a exemplarily comprises a feeding structure especially for connecting the first multitude of coils to the above-mentioned control unit 12, wherein a part of said feeding structure is representatively equipped with reference sign 23a.

It is noted that it might be particularly advantageous if the first multitude of coils is integrated into a plate or a mat or any kind thereof especially for being stepped on. It is further noted that any kind of a covered cavity especially for being stepped on can comprise the first multitude of coils or at least a part thereof.

Moreover, in accordance with the second exemplary embodiment 21b of FIG. 2B, said second exemplary embodiment 21b comprises a second multitude of coils, wherein one of said coils is representatively equipped with reference sign 22b.

At least a part or each of the coils of said second multitude is oriented according to a second direction, especially a vertical direction or y-direction. Furthermore, the second exemplary embodiment 21b exemplarily comprises a feeding structure especially for connecting the second multitude of coils to the above-mentioned control unit 12, wherein a part of said feeding structure is representatively equipped with reference sign 23b.

By analogy with the first exemplary embodiment 21a of FIG. 2A, it is noted that it might be particularly advantageous if the second multitude of coils is integrated into a plate or a mat or any kind thereof especially for being stepped on. It is further noted that any kind of a covered cavity especially for being stepped on can comprise the second multitude of coils or at least a part thereof.

Furthermore, the third exemplary embodiment 21c according to FIG. 2C is based on the first exemplary embodiment 21a of FIG. 2A and the second exemplary embodiment 21b of FIG. 2B, wherein the first multitude of coils and the second multitude of coils are superimposed or stacked especially on top of one another. Accordingly, the explanations above regarding FIG. 2A and FIG. 2B can analogously apply.

It is noted that it might be particularly advantageous if the first direction regarding the part or each of the coils of the first multitude and the second direction regarding the part or each of the coils of the second multitude are arranged in a perpendicular or substantially perpendicular manner with respect to each other.

With respect to the above-mentioned term “substantially perpendicular”, it is noted that said term can especially be understood as a deviation of not more than 30 degrees, preferably not more than 20 degrees, more preferably not more than 10 degrees, most preferably not more than 5 degrees, from 90 degrees.

For the sake of completeness, it is noted that as it can be seen from FIG. 2A, FIG. 2B, FIG. 2C, a part or each of the coils of the first multitude and/or the second multitude are physically arranged such that the coils, especially neighboring coils, are equidistant with respect to each other. In this context, it might be particularly advantageous if the control unit 12 is configured to use the corresponding one of the inductive transceiver element fields 21a, 21b, or 21c such that the respectively used coils of the first multitude and/or the second multitude are virtually arranged at different distance from one another.

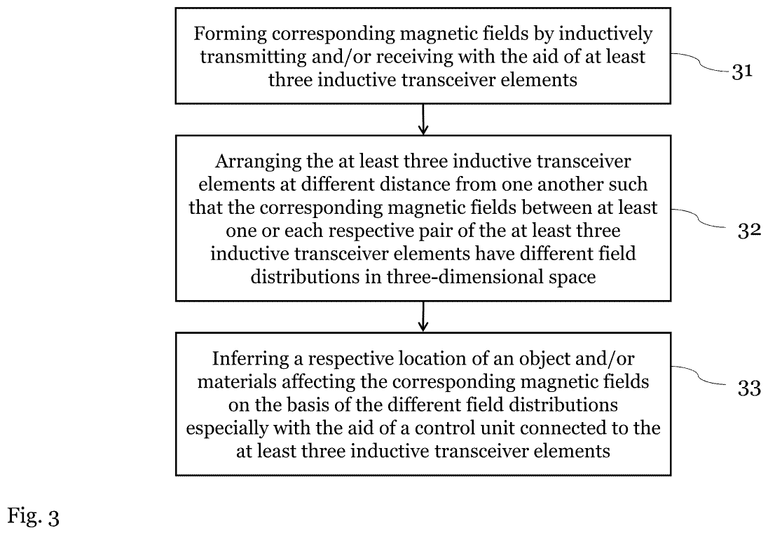

Finally, FIG. 3 illustrates a flow chart of an exemplary embodiment of the method for inductive scanning according to the second aspect of the present disclosure.

In accordance with said FIG. 3, a first step 31 comprises forming corresponding magnetic fields by inductively transmitting and/or receiving with the aid of at least three inductive transceiver elements such as the above-mentioned inductive transceiver elements 11a, 11b, 11c according to FIG. 1.

Moreover, a second step 32 comprises arranging the at least three inductive transceiver elements at different distance from one another such that the corresponding magnetic fields between at least one or each respective pair of the at least three inductive transceiver elements have different field distributions in three-dimensional space.

Advantageously, a desired scanning depth can efficiently be adjusted by varying the distances between the corresponding ones of the respective pairs of the at least three inductive transceiver elements. In this context, the farther apart the corresponding inductive transceiver elements of the respective pair are with respect to each other, the greater the corresponding scanning depth is, thereby especially allowing for scanning higher objects.

As it can further be seen from FIG. 3, a third step 33 comprises inferring a respective location of an object and/or materials affecting the corresponding magnetic fields on the basis of the different field distributions especially with the aid of a control unit, such as the above-mentioned control unit 12 of the inductive scanner 10 according to FIG. 1, connected to the at least three inductive transceiver elements.

It is noted that the method according to FIG. 3 may use the inductive scanner 10 according to FIG. 1. Accordingly, all the explanations regarding FIG. 1 above may analogously apply for the method of FIG. 3, and vice versa.

It is further noted that it might be particularly advantageous if the method further comprises the step of applying various excitation patterns to at least a part or each of the at least three inductive transceiver elements especially with the aid of the control unit.

Moreover, the method may further comprise the step of determining a three-dimensional shape with respect to the object and/or materials based on applying the various excitation patterns especially with the aid of the control unit.

Furthermore, the method may comprise the step of changing the various excitation patterns in each of various time slots especially with the aid of the control unit.

It is noted that it might be particularly advantageous if at least a part or each of the at least three inductive transceiver elements comprises or is at least one coil, especially at least one metal detection coil.

It is further noted that it might be particularly advantageous if the control unit comprises or is a controller or an application-specific integrated circuit, especially an application-specific integrated circuit acquisition unit.

Moreover, the method may comprise or be a method for inductive shoe and/or foot scanning especially used in the context of security areas such as airport security, loss prevention, protection of restricted areas, or border customs. Accordingly, the method may exemplarily be used for scanning the shoe 13 and/or foot 14 according to FIG. 1.

In this context, it might be particularly advantageous if the method further comprises the step of determining if the object and/or materials is a threat based on the respective location and/or three-dimensional shape especially with the aid of the control unit.

In addition to this or as an alternative, it might be particularly advantageous if the method further comprises the step of using machine learning and/or artificial intelligence and/or at least one artificial neural network to classify the object and/or materials.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above-described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of serveral implementations, such feature may be combined with one or more other features of the other implementations as may be desired and advantageous for any given or particular application.

What is claimed is:

1. An inductive scanner comprising:
at least three inductive transceiver elements for inductively transmitting and/or receiving to form corresponding magnetic fields, and
a control unit connected to said at least three inductive transceiver elements,
wherein the at least three inductive transceiver elements are arranged at different distance from one another such that the corresponding magnetic fields between at least one or each respective pair of the at least three inductive transceiver elements have different field distributions in three-dimensional space, and
wherein the control unit is configured to infer a respective location of an object and/or materials affecting the corresponding magnetic fields on the basis of the different field distributions.

2. The inductive scanner according to claim 1,
wherein the control unit is configured to apply various excitation patterns to at least a part or each of the at least three inductive transceiver elements.

3. The inductive scanner according to claim 2,
wherein the control unit is configured to determine a three-dimensional shape with respect to the object and/or materials based on applying the various excitation patterns.

4. The inductive scanner according to claim 2,
wherein the control unit is configured to change the various excitation patterns in each of various time slots.

5. The inductive scanner according to claim 1,
wherein at least a part or each of the at least three inductive transceiver elements comprises or is at least one coil, especially at least one metal detection coil.

6. The inductive scanner according to claim 1,
wherein the control unit comprises or is a controller or an application-specific integrated circuit, especially an application-specific integrated circuit acquisition unit.

7. The inductive scanner according to claim 1,
wherein the inductive scanner comprises or is an inductive shoe and/or foot scanner especially for security areas such as airport security.

8. The inductive scanner according to claim 7,
wherein the control unit is configured to determine if the object and/or materials is a threat based on the respective location and/or three-dimensional shape.

9. The inductive scanner according to claim 7,
wherein the control unit is configured to use machine learning and/or artificial intelligence and/or at least one artificial neural network to classify the object and/or materials.

10. A method for inductive scanning, said method comprising the steps of:
forming corresponding magnetic fields by inductively transmitting and/or receiving with the aid of at least three inductive transceiver elements,
arranging the at least three inductive transceiver elements at different distance from one another such that the corresponding magnetic fields between at least one or each respective pair of the at least three inductive transceiver elements have different field distributions in three-dimensional space, and
inferring a respective location of an object and/or materials affecting the corresponding magnetic fields on the basis of the different field distributions especially with the aid of a control unit connected to the at least three inductive transceiver elements.

11. The method according to claim 10,
wherein the method further comprises the step of:
applying various excitation patterns to at least a part or each of the at least three inductive transceiver elements especially with the aid of the control unit.

12. The method according to claim 11,
wherein the method further comprises the step of:
determining a three-dimensional shape with respect to the object and/or materials based on applying the various excitation patterns especially with the aid of the control unit.

13. The method according to claim 11,
wherein the method further comprises the step of:
changing the various excitation patterns in each of various time slots especially with the aid of the control unit.

14. The method according to claim 10,
wherein at least a part or each of the at least three inductive transceiver elements comprises or is at least one coil, especially at least one metal detection coil.

15. The method according to claim 10,
wherein the control unit comprises or is a controller or an application-specific integrated circuit, especially an application-specific integrated circuit acquisition unit.

16. The method according to claim 10,
wherein the method comprises or is a method for inductive shoe and/or foot scanning especially used in the context of security areas such as airport security.

17. The method according to claim 16,
wherein the method further comprises the step of:
determining if the object and/or materials is a threat based on the respective location and/or three-dimensional shape especially with the aid of the control unit.

18. The method according to claim 16,
wherein the method further comprises the step of:
using machine learning and/or artificial intelligence and/or at least one artificial neural network to classify the object and/or materials.
